(19) United States
(12) Patent Application Publication
(10) Pub. No.: US 2026/0250433 A1
(43) Pub. Date: Aug. 27, 2026

(54) RESIN MICROPARTICLES AND METHOD FOR PRODUCING SAME

(71) Applicant: SEKISUI KASEI CO., LTD., Osaka (JP)

(72) Inventor: Kohei TANAKA, Osaka (JP)

(73) Assignee: SEKISUI KASEI CO., LTD., Osaka (JP)

(21) Appl. No.: 18/994,347

(22) PCT Filed: Aug. 1, 2023
(86) PCT No.: PCT/JP2023/028123

§ 371 Date: Jan. 14, 2025

(30) Foreign Application Priority Data
Aug. 29, 2022 (JP) 2022-135836

(51) Int. Cl. C08F 20/10; C08F 2/22; C08F 12/08; C08F 12/12; C08F 12/30; C08K 5/00

(52) U.S. Cl. CPC C08F 20/10; C08F 2/22; C08F 12/08; C08F 12/12; C08F 12/30; C08K 5/005

(57) ABSTRACT

An object is to provide resin microparticles that are made of a general-purpose material and exhibit both high monodispersity and excellent heat resistance, and a method for producing the same. As a solution, the present invention provides resin microparticles obtained by polymerizing vinyl-based monomers, the resin microparticles containing an antioxidant with a melting point of 30° C. or higher and 105° C. or lower and a multifunctional thiol compound and/or a monofunctional thiol compound having an alkyl group having 1 to 9 carbon atoms in the molecule, moreover the resin microparticles having a volume average primary particle size of 0.05 μm or more and 3.0 μm or less, and a coefficient of variation of the volume average primary particle size of 20% or less.

### TECHNICAL FIELD

The present invention relates to resin microparticles and a method for producing the same, and, more specifically, relates to resin microparticles that exhibit both high monodispersity and excellent heat resistance, and a method for producing the same.

### BACKGROUND ART

Resin microparticles with high monodispersity and excellent heat resistance are materials that are expected to be used in a wide range of fields, so as to be used as anti-blocking agents for various resin films, spacers for LCDs, light diffusing agents and anti-glare property imparting materials used in various display devices, toner additives for electrostatic image development, powder paints and water-based paints, cosmetic additives and cosmetic fillers, column fillers for chromatography, and various semiconductor abrasives.

Methods for adjusting the monodispersity of resin microparticles include a method for performing adjustment according to a polymerization form and a method for selecting only a desired particle size range according to classification, and, in consideration of productivity, a method in which the particles have a uniform particle size during polymerization is most preferable.

As polymerization methods for obtaining resin microparticles with high monodispersity, emulsion polymerization, soap-free polymerization, seed polymerization, dispersion polymerization and the like are generally known.

PTL 1 and 2 each describe a method for producing resin microparticles with high monodispersity by seed polymerization.

PTL 3 describes, as a method for obtaining resin microparticles having excellent heat resistance, a method in which an antioxidant is dissolved in a monomer phase in advance during suspension polymerization, and the antioxidant is encapsulated inside the resin microparticles after polymerization.

PTL 4 describes a method for producing resin microparticles with high monodispersity by using engineering plastics as a material having excellent heat resistance.

### CITATION LIST

### Patent Literature

PTL 1: Japanese Patent Application Publication No. S62-121701
PTL 2: Japanese Patent Application Publication No. 2001-2716
PTL 3: WO 2008/133147
PTL 4: Japanese Patent Application Publication No. 2014-043522

### SUMMARY OF INVENTION

### Technical Problem

In order to obtain resin microparticles that are made of a general-purpose material such as an acrylic resin and that exhibit both excellent heat resistance and monodispersity, it is necessary to add thereto an antioxidant in the polymerization method by which a uniform particle size is obtained.

In many polymerization methods by which a uniform particle size is obtained, water is used as a dispersion medium. However, many antioxidants are often insoluble in water, and when an antioxidant dissolved in a monomer phase is used, it is difficult to obtain resin microparticles having a uniform particle size. In addition, in the polymerization method by which a uniform particle size is obtained, water-soluble polymers such as a polyvinyl alcohol are often used as dispersion stabilizers, but these are not preferable because, when resin microparticles obtained using these polymers are exposed to a heating environment, coloring occurs.

The resin microparticles made of engineering plastics and having excellent monodispersity and heat resistance cannot be considered as general-purpose materials due to problems in terms of productivity and production cost.

The present invention has been made with focus on the above problems. An object to be achieved by the present invention is to provide resin microparticles that are made of a general-purpose material and exhibit both high monodispersity and excellent heat resistance, and a method for producing the same.

### Solution to Problem

The inventors conducted extensive studies in order to achieve the above object, and as a result, found that the above object can be achieved with resin microparticles having, in a specific range, a volume average primary particle size and, also in a specific range, a coefficient of variation of the volume average primary particle size, the resin microparticles containing an antioxidant with a melting point in a specific range, and moreover containing a specific thiol compound, and completed the present invention.

Specifically, the present invention provides resin microparticles and a method for producing the resin microparticles below.
[Aspect 1] Resin microparticles obtained by polymerizing vinyl-based monomers, the resin microparticles including:
an antioxidant with a melting point of 30° C. or higher and 105° C. or lower; and
a multifunctional thiol compound and/or a monofunctional thiol compound having an alkyl group having 1 to 9 carbon atoms in a molecule,
the resin microparticles having a volume average primary particle size of 0.05 μm or more and 3.0 μm or less, and a coefficient of variation of the volume average primary particle size of 20% or less.
[Aspect 2] The resin microparticles according to Aspect 1,
wherein a silicon element content in the resin microparticles measured by fluorescent X-ray analysis is 0.03 mass % or more and 1 mass % or less.
[Aspect 3] The resin microparticles according to Aspect 1 or 2,
wherein a 3% decomposition temperature in an air atmosphere is 290° C. or higher, and a 3% decomposition temperature in an inert gas atmosphere is 340° C. or higher.
[Aspect 4] The resin microparticles according to any one of Aspects 1 to 3,
wherein the vinyl-based monomers include a monofunctional (meth)acrylic acid ester-based monomer having an alkyl group having 1 to 8 carbon atoms.
[Aspect 5] The resin microparticles according to any one of Aspects 1 to 4,
wherein the vinyl-based monomers include a monofunctional aromatic vinyl-based monomer.
[Aspect 6] The resin microparticles according to any one of Aspects 1 to 5,
wherein the vinyl-based monomers include a multifunctional vinyl-based monomer.
[Aspect 7] The resin microparticles according to any one of Aspects 1 to 6,
wherein the resin microparticles contain a non-crosslinkable polymer component made of a monomer component containing a (meth)acrylic acid ester-based monomer or an aromatic vinyl-based monomer.
[Aspect 8] The resin microparticles according to any one of Aspects 1 to 7, which are used as an anti-blocking agent for a resin film.
[Aspect 9] The resin microparticles according to Aspect 8,
wherein the resin film is an optical film.
[Aspect 10]A method for producing resin microparticles, the method including
a process of performing, in an aqueous medium, heat treatment on a mixture of polymer particles obtained by polymerizing monomer components, and an antioxidant or an antioxidant dispersing liquid,
wherein the monomer components include a monofunctional (meth)acrylic-based monomer or a monofunctional aromatic vinyl-based monomer.
[Aspect 11] The method for producing resin microparticles according to Aspect 10,
wherein the temperature during the heat treatment is equal to or higher than a melting point of the antioxidant and 120° C. or lower.
[Aspect 12] The method for producing resin microparticles according to Aspect 10 or 11,
wherein the polymer particles are polymer particles obtained by seed polymerization, emulsion polymerization or soap-free polymerization.
[Aspect 13] The method for producing resin microparticles according to any one of 10 to 12,
wherein the polymer particles are polymer particles polymerized in the absence of a water-soluble polymer.
[Aspect 14] The method for producing resin microparticles according to any one of Aspects 10 to 13, further including a process of granulating and drying the resin microparticles.
[Aspect 15] The method for producing resin microparticles according to any one of Aspects 10 to 14, further including a process of dry-classifying and/or wet-classifying the resin microparticles.

### Advantageous Effects of Invention

The present invention provides resin microparticles that are made of a general-purpose material and exhibit both high monodispersity and excellent heat resistance, and a method for producing the same.

The resin microparticles of the present invention exhibit both high monodispersity and excellent heat resistance. Therefore, the resin microparticles can be suitably used in applications for which particle size control is required with high accuracy, for example, and even when the resin microparticles are used as anti-blocking agents for various resin films for optical applications that are produced through a kneading process at a high temperature, it is possible to produce films in which the resin microparticles are aligned with high accuracy without generating gases during thermal degradation or thermal decomposition of the resin microparticles. The resin microparticles of the present invention can be applied in a wide range of fields such as anti-blocking agents for various resin films, spacers for LCDs, light diffusing agents and anti-glare property imparting materials for films used in various display devices, toner additives for electrostatic image development, powder paints and water-based paints, cosmetic additives and cosmetic fillers, column fillers for chromatography, and various semiconductor abrasives. Particularly, the resin microparticles can be suitably used as anti-blocking agents for various resin films used in optical applications.

### DESCRIPTION OF EMBODIMENTS

Hereinafter, resin microparticles and a method for producing resin microparticles of the present invention will be described in detail. The present invention is not limited to the following embodiments, and can be performed in various modifications within the scope of the present invention.

In this specification, the (meth)acrylic-based monomer is an acrylic-based monomer or methacrylic-based monomer, (meth)acrylic is acrylic or methacrylic, and (meth)acrylate is acrylate or methacrylate.

### [Resin Microparticles]

The resin microparticles of the present invention are resin microparticles obtained by polymerizing vinyl-based monomers, containing an antioxidant with a melting point of 30° C. or higher and 105° C. or lower and a multifunctional thiol compound and/or a monofunctional thiol compound having an alkyl group having 1 to 9 carbon atoms in the molecule, having a volume average primary particle size of 0.05 μm or more and 3.0 μm or less and a coefficient of variation of the volume average primary particle size of 20% or less.

In the resin microparticles of the present invention, the silicon element content in the resin microparticles measured by fluorescent X-ray analysis may be 0.03 mass % or more and 1 mass % or less.

In the resin microparticles of the present invention, the 3% decomposition temperature in an air atmosphere may be 290° C. or higher, and the 3% decomposition temperature in an inert gas atmosphere may be 340° C. or higher.

In the resin microparticles of the present invention, the vinyl-based monomers may include a monofunctional (meth)acrylic acid ester-based monomer having an alkyl group having 1 to 8 carbon atoms.

In the resin microparticles of the present invention, the vinyl-based monomers may include a monofunctional aromatic vinyl-based monomer.

In the resin microparticles of the present invention, the vinyl-based monomers may include a multifunctional vinyl-based monomer.

In the resin microparticles of the present invention, the resin microparticles may contain a non-crosslinkable polymer component made of a monomer component containing a (meth)acrylic acid ester-based monomer or an aromatic vinyl-based monomer.

The resin microparticles of the present invention may be used as an anti-blocking agent for a resin film, and the resin film may be an optical film.

### <Vinyl-Based Monomers>

The resin microparticles of the present invention are obtained by polymerizing vinyl-based monomers.

Examples of vinyl-based monomers include one or more selected from among a monofunctional vinyl-based monomer having one radically polymerizable unsaturated group per molecule and a multifunctional vinyl-based monomer having two or more radically polymerizable unsaturated groups per molecule. In addition, the radically polymerizable unsaturated group is one or more selected from the group consisting of a (meth)acryloyl group, a (meth)acrylamide group, a vinyl group, a styryl group, and an allyl group.

As the monofunctional vinyl-based monomer, for example, one or more selected from the group consisting of monofunctional (meth)acrylic-based monomers, monofunctional aromatic vinyl-based monomers and hydrolyzable silyl group-containing vinyl-based monomers are preferable.

As the multifunctional vinyl-based monomer, for example, one or more selected from the group consisting of multifunctional (meth)acrylic-based monomers and multifunctional aromatic vinyl-based monomers are preferable.

In the present invention, “other vinyl-based monomers” other than monofunctional (meth)acrylic-based monomers, monofunctional aromatic vinyl-based monomers, hydrolyzable silyl group-containing vinyl-based monomers, multifunctional (meth)acrylic-based monomers and multifunctional aromatic vinyl-based monomers may be used. Examples of other vinyl-based monomers include one or more selected from the group consisting of fatty acid vinyl ester-based monomers, halogenated olefin-based monomers, cyanide vinyl-based monomers, unsaturated carboxylic acid-based monomers, unsaturated polycarboxylate-based monomers, unsaturated carboxylic acid amide-based monomers, unsaturated carboxylic acid amide methylolated component-based monomers, multifunctional allyl-based monomers and multifunctional unsaturated carboxylic acid amide-based monomers.

### (Monofunctional (Meth)Acrylic-Based Monomers)

Examples of monofunctional (meth)acrylic-based monomers include one or more selected from the group consisting of (meth)acrylic acid alkyl esters in which the number of carbon atoms of the alkyl group bonded to an ester is 1 or more and 20 or less, such as methyl (meth)acrylate (methyl methacrylate, methyl acrylate), ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isostearyl (meth)acrylate, nonadecyl (meth)acrylate, and eicosyl (meth)acrylate; (meth)acrylic acid esters having an alicyclic structure in the ester moiety such as cyclohexyl (meth)acrylate, isobornyl (meth)acrylate, and dicyclopentanyl (meth)acrylate; and (meth)acrylic acid esters having an aromatic ring in the molecular structure such as benzyl (meth)acrylate, phenyl (meth)acrylate, phenoxyethyl (meth)acrylate, and 2-(meth)acryloyloxyethyl phthalate.

In the present invention, it is generally preferable to use one or more selected from the group consisting of methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate and isooctyl (meth)acrylate, in which the number of carbon atoms of alkyl groups bonded to an ester is 1 or more and 8 or less. Particularly, in applications for which heat resistance is required, one or more selected from the group consisting of methyl acrylate, ethyl acrylate and butyl acrylate are preferable. These monofunctional (meth)acrylic-based monomers may be used alone or two or more thereof may be used in combination.

### (Monofunctional Aromatic Vinyl-Based Monomers)

Examples of monofunctional aromatic vinyl-based monomers include one or more selected from the group consisting of styrene, o-methylstyrene, m-methylstyrene, p-methylstyrene, α-methylstyrene, t-butylstyrene, vinylnaphthalene, styrene sulfonic acid, styrene sulfonate (sodium styrene sulfonate, ammonium styrene sulfonate, etc.), vinyl benzoate, hydroxystyrene, m-ethylvinylbenzene, p-ethylvinylbenzene, allylbenzene and the like. In the present invention, one or more selected from the group consisting of styrene, α-methylstyrene, and sodium styrene sulfonate are preferable. These monofunctional aromatic vinyl-based monomers may be used alone or two or more thereof may be used in combination.

### (Hydrolyzable Silyl Group-Containing Vinyl-Based Monomers)

The hydrolyzable silyl group-containing vinyl-based monomers are one or more selected from the group consisting of monomers having a hydrolyzable silyl group and a group that reacts with a radically polymerizable unsaturated group in the molecule.

The hydrolyzable silyl group in the hydrolyzable silyl group-containing vinyl-based monomer is a silicon-containing group in which 1 to 3 hydrolyzable groups are bonded to a silicon atom and which can undergo a condensation reaction in the presence of moisture, a cross-linking agent or the like, as necessary, using a catalyst or the like, form siloxane bonds and crosslink them. The hydrolyzable group in the hydrolyzable silyl group is not particularly limited, and examples thereof include one or more selected from the group consisting of a hydrogen atom, a halogen atom, a hydroxy group, an alkoxy group, a phenoxy group, an aryloxy group, an acyloxy group, a ketoximate group, an amino group, an amide group, an acid amide group, an aminoxy group, an iminoxy group, a mercapto group, an alkenyloxy group, and an oxime group.

Among these, an alkoxysilyl group is preferable because it undergoes a gentle hydrolysis reaction and is easy to handle. Examples of alkoxysilyl groups include trialkoxysilyl groups such as a trimethoxysilyl group, a triethoxysilyl group, a triisopropoxysilyl group, and a triphenoxysilyl group; dialkoxysilyl groups such as a propyldimethoxysilyl group, a methyldimethoxysilyl group, and a methyldiethoxysilyl group; and monoalkoxysilyl groups such as a dimethyl methoxysilyl group and a dimethylethoxysilyl group. A trialkoxysilyl group is preferable, and a trimethoxysilyl group and a triethoxysilyl group are more preferable.

Groups other than the hydrolyzable group bonded to the silicon atom in the hydrolyzable silyl group are not particularly limited. Examples thereof include one or more selected from the group consisting of alkyl groups having 20 or less carbon atoms such as a methyl group, an ethyl group, a propyl group, and an isopropyl group, alkenyl groups having 20 or less carbon atoms, aryl groups having 6 to 30 carbon atoms, and arylalkyl groups having 7 to 30 carbon atoms.

The group that reacts with a radically polymerizable unsaturated group in the hydrolyzable silyl group-containing vinyl-based monomer is not particularly limited as long as it is a group that reacts with a radically polymerizable unsaturated group such as a (meth)acryloyl group, a (meth)acrylamide group, a vinyl group, or a styryl group. Examples thereof include one or more selected from the group consisting of radically polymerizable unsaturated groups such as a (meth)acryloyl group, a (meth)acrylamide group, a vinyl group, and a styryl group, a mercapto group, a hydroxyl group, and an amino group.

Examples of hydrolyzable silyl group-containing vinyl-based monomers include one or more selected from the group consisting of vinyltrimethoxysilane, vinyltriethoxysilane, p-styryltrimethoxysilane, 3-methacryloxypropyl methyl dimethoxy silane, 3-methacryloxypropyltrimethoxysilane, 3-methacryloxypropyl methyl diethoxy silane, 3-methacryloxypropyl triethoxy silane, 3-acryloxypropyltrimethoxy silane, 3-mercaptopropyl methyl dimethoxy silane, and 3-mercaptopropyltrimethoxy silane. These may be used alone or two or more thereof may be used in combination.

### (Multifunctional (Meth)Acrylic-Based Monomers)

Examples of multifunctional (meth)acrylic-based monomers include one or more selected from the group consisting of ethylene glycol di(meth)acrylate, diethylene glycol di(meth)acrylate, triethylene glycol di(meth)acrylate, decaethylene glycol di(meth)acrylate, pentadecaethylene glycol di(meth)acrylate, pentaconta hexaethylene glycol di(meth)acrylate, propylene glycol di(meth)acrylate, dipropylene glycol di(meth)acrylate, 1,3-butylene di(meth)acrylate, allyl (meth)acrylate, trimethylolpropane tri(meth)acrylate, and pentaerythritol tetraacrylate. Among these, one or more selected from the group consisting of ethylene glycol dimethacrylate, ethylene glycol diacrylate, allyl methacrylate, and allyl acrylate are preferable. These multifunctional (meth)acrylic-based monomers may be used alone or two or more thereof may be used in combination.

### (Multifunctional Aromatic Vinyl-Based Monomers)

Examples of multifunctional aromatic vinyl-based monomers include one or more selected from the group consisting of m- or p-divinylbenzene, 1,3-, 1,8-, 1,4-, 1,5-, 2,3-, 2,6- or 2,7-divinylnaphthalene, 4,4′-, 4,3′-, 2,2′- or 2,4-divinylbiphenyl, 1,2-, 1,3-, 1,4-diisopropenylbenzene, 1,2-divinyl-3,4-dimethylbenzene and multifunctional aromatic vinyl-based monomer derivatives in which aromatic rings of these multifunctional aromatic vinyl-based monomers are substituted with one or more substituents such as an alkyl group having 1 to 6 carbon atoms, a halogen group, an alkoxy group having 1 to 6 carbon atoms, a hydroxy group, an acyl group having 1 to 6 carbon atoms, a carboxyl group, a sulfonic acid group, and a sulfonate group. These multifunctional aromatic vinyl-based monomers may be used alone or two or more thereof may be used in combination.

### (Other Vinyl-Based Monomers)

Among the other vinyl-based monomers, examples of fatty acid vinyl ester-based monomers include vinyl acetate and vinyl propionate. These fatty acid vinyl ester-based monomers may be used alone or two or more thereof may be used in combination.

Among the other vinyl-based monomers, examples of halogenated olefin-based monomers include vinyl chloride, vinylidene chloride, tetrafluoroethylene, and vinylidene fluoride. These halogenated olefin-based monomers may be used alone or two or more thereof may be used in combination.

Among the other vinyl-based monomers, examples of cyanide vinyl-based monomers include (meth)acrylonitrile.

Among the other vinyl-based monomers, the unsaturated carboxylic acid-based monomers include unsaturated carboxylic acids, and their salts or anhydrides, for example, (meth)acrylic acid, crotonic acid, maleic acid, fumaric acid, their ammonium or metal salts, and maleic anhydride. These unsaturated carboxylic acid-based monomers may be used alone or two or more thereof may be used in combination.

Among the other vinyl-based monomers, the unsaturated polycarboxylate-based monomers include unsaturated dicarboxylic acid monoesters, their salts, and unsaturated dicarboxylic acid diesters, for example, monobutyl maleate, their ammonium or metal salts, and dimethyl maleate. These unsaturated polycarboxylate-based monomers may be used alone or two or more thereof may be used in combination.

Among the other vinyl-based monomers, the unsaturated carboxylic acid amide-based monomers include, for example, (meth)acrylamide, and diacetone (meth)acrylamide. These unsaturated carboxylic acid amide-based monomers may be used alone or two or more thereof may be used in combination.

Among the other vinyl-based monomers, the unsaturated carboxylic acid amide methylolated component-based monomers include, for example, N-methylol acrylamide, N-methylol methacrylamide, methylolated diacetone acrylamide, and ether compounds of these monomers and alcohols having 1 to 8 carbon atoms. These unsaturated carboxylic acid amide methylolated component-based monomers may be used alone or two or more thereof may be used in combination.

Among the other vinyl-based monomers, the multifunctional allyl-based monomers include, for example, diallyl phthalate, and triallyl cyanurate. These multifunctional allyl-based monomers may be used alone or two or more thereof may be used in combination.

Among the other vinyl-based monomers, the multifunctional unsaturated carboxylic acid amide-based monomers include, for example, ethylene glycol di(meth)acrylamide, and diethylene glycol di(meth)acrylamide. These multifunctional unsaturated carboxylic acid amide-based monomers may be used alone or two or more thereof may be used in combination.

### (Composition of Vinyl-Based Monomers)

The amounts of the monomers constituting the resin microparticles to be used can be appropriately determined depending on applications of the resin microparticles, desired properties and the like, and are not particularly limited.

The amount of the monofunctional (meth)acrylic-based monomers based on a total amount of 100 mass % of all monomers constituting the resin microparticles is, for example, 10 mass % or more, and preferably 15 mass % or more, and for example, 90 mass % or less, and preferably 85 mass % or less.

The amount of the monofunctional aromatic vinyl-based monomers based on a total amount of 100 mass % of all monomers constituting the resin microparticles is 0 mass % or more, and for example, 5 mass % or more, and for example, 70 mass % or less, and preferably 60 mass % or less.

The amount of the hydrolyzable silyl group-containing vinyl-based monomers based on a total amount of 100 mass % of all monomers constituting the resin microparticles is, for example, 0 mass % or more, preferably 0.1 mass % or more, and more preferably 0.5 mass % or more, and for example, 10 mass % or less, and preferably 5 mass % or less.

The amount of the multifunctional (meth)acrylic-based monomer units based on a total amount of 100 mass % of all monomers constituting the resin microparticles is, for example, 3 mass % or more, and preferably 5 mass % or more, and for example, 50 mass % or less, and preferably 40 mass % or less.

The amount of the multifunctional aromatic vinyl-based monomers based on a total amount of 100 mass % of all monomers constituting the resin microparticles is 0 mass % or more, for example, 5 mass % or more, and for example, 70 mass % or less, and preferably 60 mass % or less.

The amount of the other monomers based on a total amount of 100 mass % of all monomers constituting the resin microparticles is 0 mass % or more, for example, 5 mass % or more, and for example, 50 mass % or less, and preferably 40 mass % or less.

### <Antioxidant>

The resin microparticles of the present invention contain an antioxidant with a melting point of 30° C. or higher and 105° C. or lower. The antioxidant is not particularly limited. Examples thereof include one or more selected from the group consisting of phenol-based, phosphorus-based, sulfur-based, and amine-based antioxidants.

The melting point of the antioxidant contained in the resin microparticles of the present invention is 30° C. or higher and 105° C. or lower. When an antioxidant with a melting point of lower than 30° C. is used, there is a risk of the antioxidant being liquefied due to the outdoor temperature when the resin microparticles are collected as a dry powder. When an antioxidant with a melting point above 105° C. is used, there is a risk of the dispersion stability of the resin microparticle dispersing liquid being affected during the heat treatment.

In the present invention, an antioxidant that is in a powder state at room temperature (25° C.) can be used. In addition, an antioxidant that is dispersed or dissolved in water, an alcohol or the like may be used.

The content of the antioxidant in the resin microparticles is not particularly limited. The content based on a total amount of 100 mass % of the resin microparticles is, for example, 0.05 mass % or more, and preferably 0.1 mass % or more, and for example, 5 mass % or less, and preferably 3 mass % or less.

As the phenol-based antioxidant, a compound having a substituent such as an alkyl group at the ortho position relative to the phenolic hydroxyl group is preferable. In addition, in the present invention, it is preferable not to use p-methoxyphenol in order to sufficiently increase the 3% decomposition temperature in an air atmosphere and/or the 3% decomposition temperature in an inert gas atmosphere.

Examples of phenol-based antioxidants include one or more selected from the group consisting of 3-(4′-hydroxy-3′,5-di-tert-butylphenyl)propion-n-octadecyl, ethylenebis(oxyethylene)bis[3-(5-tert-butyl-4-hydroxy-m-tolyl)propionate], 1,6-hexanediol bis[3-(3,5-di-tert-butyl-4-hydroxyphenyl)propionate], 4-[[4,6-bis(octylthio)-1,3,5-triazin-2-yl]amino]-2,6-di-tert-butylphenol, and 2,2′-thiodiethylbis[3-(3,5-di-tert-butyl-4-hydroxyphenyl)propionate].

Examples of amine-based antioxidants include one or more selected from the group consisting of bis(2,2,6,6-tetramethyl-4-piperidyl) sebacate, butane-1,2,3,4-tetracarboxylic acid tetrakis(1,2,2,6,6-pentamethyl-4-piperidinyl), and 2,2,6,6-tetramethyl-4-piperidyl methacrylate.

Examples of phosphorus-based antioxidants include one or more selected from the group consisting of 3,9-dioctadecan-1-yl-2,4,8,10-tetraoxa-3,9-diphosphaspiro(5.5)undecane.

Examples of sulfur-based antioxidants include one or more selected from the group consisting of 3,3′-dioctadecyl thiodipropionate, and pentaerythritol tetrakis[3-(dodecylthio)propionate].

In the resin microparticles of the present invention, an antioxidant having a radical scavenging ability is preferable, one or more antioxidant selected from the group consisting of phenol-based and amine-based antioxidants are preferable, and one or more phenol-based antioxidants are more preferable.

<Multifunctional Thiol Compound and/or Monofunctional Thiol Compound Having Alkyl Group Having 1 to 9 Carbon Atoms in Molecule>

The resin microparticles of the present invention contain a multifunctional thiol compound and/or a monofunctional thiol compound having an alkyl group having 1 to 9 carbon atoms in the molecule. In the present invention, it is preferable to contain a multifunctional thiol compound.

The content of the multifunctional thiol compound and/or the monofunctional thiol compound having an alkyl group having 1 to 9 carbon atoms in the molecule in the resin microparticles is not particularly limited. The content based on a total amount of 100 mass % of the resin microparticles is, for example, 0.05 mass % or more, preferably 0.1 mass % or more, and more preferably 0.3 mass % or more, and for example, 5 mass % or less, and preferably 3 mass % or less.

The thiol compound functions as a chain transfer agent and becomes a structural unit of polymer microparticles. In a radical polymerization system in which a hydrolyzable silicon compound having a hydrolyzable silyl group and a group that reacts with a radically polymerizable unsaturated group, monofunctional (meth)acrylic-based monomers and multifunctional (meth)acrylic-based monomers are polymerized, the thiol compound receives a radical from the growing polymer chain to terminate the elongation of the polymer chain, and generates a new radical to initiate the growth reaction of another polymer chain. Therefore, it is possible to make the molecular weight of the resin microparticles uniform and make the particle size distribution uniform.

### (Multifunctional Thiol Compound)

The multifunctional thiol compound is not particularly limited as long as it is a compound having two or more thiol groups in the molecule. Examples thereof include one or more selected from the group consisting of 1,2-ethanedithiol, 1,3-propanedithiol, 1,4-butanedithiol, 1,6-hexanedithiol, 1,8-octanedithiol, 1,2-cyclohexanedithiol, decanedithiol, ethylene glycol bisthioglycolate, ethylene glycol bisthiopropionate, ethylene glycol bisthioglycolate (EGTG), 1,4-butanediol bisthiopropionate (BDTG), trimethylolpropane tristhioglycolate (TMTG), trimethylolpropane tristhiopropionate, pentaerythritol tetrakisthioglycolate (PETG), pentaerythritol tetrakis thiopropionate, dipentaerythritol hexathiopropionate, trimercaptopropionic acid tris(2-hydroxyethyl)isocyanurate, 1,4-dimethylmercaptobenzene, 2,4,6-trimercapto-s-triazine, and 2-(N,N-dibutylamino)-4,6-dimercapto-s-triazine. These multifunctional thiol compounds may be used alone or two or more thereof may be used in combination.

Among these, one or more selected from the group consisting of ethylene glycol bisthioglycolate (EGTG), 1,4-butanediol bisthiopropionate (BDTG), trimethylolpropane tristhioglycolate (TMTG), and pentaerythritol tetrakisthioglycolate (PETG) are preferable.

### (Monofunctional Thiol Compound Having Alkyl Group Having 1 to 9 Carbon Atoms in Molecule)

The monofunctional thiol compound having an alkyl group having 1 to 9 carbon atoms in the molecule is not particularly limited as long as it is a compound having one thiol group and an alkyl group having 1 to 9 carbon atoms in the molecule.

Examples thereof include methanethiol, ethanethiol, propanethiol, butanethiol, pentanethiol, hexanethiol, heptanethiol, octanethiol, nonanethiol and a compound having a branched chain structure thereof, and one or more selected from among these groups may be exemplified. These monofunctional thiol compounds may be used alone or two or more thereof may be used in combination.

### <Non-Crosslinkable Polymer Component>

The resin microparticles of the present invention may contain a non-crosslinkable polymer component made of a monomer component containing a (meth)acrylic acid ester-based monomer or an aromatic vinyl-based monomer. In the present invention, when a non-crosslinkable polymer component is contained, it is contained as seed particles when resin microparticles are obtained by seed polymerization.

As the (meth)acrylic acid ester-based monomers contained in the monomer components constituting the non-crosslinkable polymer component, for example, one or more selected from the group consisting of monofunctional (meth)acrylic-based monomers described in the section (Monofunctional (meth)acrylic-based Monomers) in <Vinyl-based Monomers> can be used.

As the aromatic vinyl-based monomers contained in the monomer components constituting the non-crosslinkable polymer component, for example, one or more selected from the group consisting of monofunctional aromatic vinyl-based monomers described in the section (Monofunctional Aromatic Vinyl-based Monomers) in <Vinyl-based Monomers> can be used.

The amount proportion of the (meth)acrylic acid ester-based monomers in the monomer components constituting the non-crosslinkable polymer component is not particularly limited, and is in a range of, for example, 10 mass % or more, and preferably 15 mass % or more, and for example, 100 mass % or less, and preferably 98 mass % or less, based on a total amount of 100 mass % of monomer components constituting the non-crosslinkable polymer component.

The amount proportion of the aromatic vinyl-based monomers in the monomer components constituting the non-crosslinkable polymer component is not particularly limited, and is in a range of, for example, 10 mass % or more, and preferably 15 mass % or more, and for example, 100 mass % or less, and preferably 98 mass % or less, based on a total amount of 100 mass % of monomer components constituting the non-crosslinkable polymer component.

### <Other Components>

The resin microparticles of the present invention may contain “Other components” other than the antioxidant, the multifunctional thiol compound and the monofunctional thiol compound having an alkyl group having 1 to 9 carbon atoms in the molecule, and the non-crosslinkable polymer component. The other components are not particularly limited, and examples thereof include one or more selected from among a photodegradation prevention agent, an ultraviolet absorbing agent (triazine-based compound, etc.), a heat fusion inhibitor (silica particles, etc.), a light diffusibility imparting agent (zirconia particles, titania particles, etc.), a heat dissipation imparting agent (alumina particles, metal particles, etc.), and a colorant.

### <Properties of Resin Microparticles>

The resin microparticles of the present invention have a volume average primary particle size and a coefficient of variation of the volume average primary particle size within specific ranges.

In addition, the resin microparticles of the present invention preferably have a silicon element content, a 3% decomposition temperature in an air atmosphere, a 3% decomposition temperature in an inert gas atmosphere and an amount of surfactant residues, each within a specific range.

### (Volume Average Primary Particle Size)

The volume average primary particle size of the resin microparticles of the present invention is 0.05 μm or more, preferably 0.08 μm or more, more preferably 0.10 μm or more, and 3.0 μm or less, preferably 2.0 μm or less, and more preferably 1.0 μm or less. When the volume average primary particle size of the resin microparticles is outside the range of 0.05 μm or more and 3.0 μm or less, there is a risk of adversely affecting optical properties when added to a film.

Regarding the method for measuring the volume average primary particle size of the resin microparticles, for example, a laser scattering/diffraction type particle size distribution measurement device (commercially available from Beckman Coulter, Inc.) can be used for measurement. The volume average primary particle size of the resin microparticles here is a numerical value determined by an arithmetical mean. As a specific method for measuring the volume average primary particle size of the resin microparticles, for example, a method described in examples below can be used.

### (Coefficient of Variation of Volume Average Primary Particle Size)

The coefficient of variation of the volume average primary particle size of the resin microparticles of the present invention is 20% or less, preferably 19% or less, and more preferably 18% or less. When the coefficient of variation of the volume average primary particle size of the resin microparticles exceeds 20%, there is a risk of it being difficult for it to form irregularities with high accuracy when added to a film.

The coefficient of variation of the volume average primary particle size of the resin microparticles is a numerical value determined by the following formula (1);

$$coefficient of variation of the volume average primary particle size of the resin microparticles = ( the standard deviation of the volume - based particle size distribution of the resin microparticles \div the volume average primary particle size of the resin microparticles ) \times 100 , \qquad ( 1 )$$

and indicates a data distribution range.

The volume average primary particle size of the resin microparticles and the standard deviation of the volume-based particle size distribution of the resin microparticles used when the coefficient of variation of the volume average primary particle size of the resin microparticles is determined can be measured, for example, a laser scattering/diffraction type particle size distribution measurement device (commercially available from Beckman Coulter, Inc.). As a specific measurement method for these, for example, a method described in examples below can be used.

### (Silicon Element Content)

In the resin microparticles of the present invention, the silicon element content in the resin microparticles measured by fluorescent X-ray analysis is preferably 0.03 mass % or more, and more preferably 0.05 mass % or more, and preferably 1 mass % or less, and more preferably 0.50 mass % or less. The resin microparticles exhibiting such properties have very excellent heat resistance and do not affect a haze or the like when formed into a film.

The silicon element in the resin microparticles in the present invention is derived mainly from the silicon element in the hydrolyzable silyl group-containing vinyl-based monomers constituting the resin microparticles. As the method for measuring the silicon element content in the resin microparticles by fluorescent X-ray analysis, for example, a method described in examples below can be used.

### (3% Decomposition Temperature in Air Atmosphere)

The resin microparticles of the present invention have a 3% decomposition temperature in an air atmosphere that is preferably 290° C. or higher, more preferably 300° C. or higher, and still more preferably 305° C. or higher.

The 3% decomposition temperature in an air atmosphere means that, when the resin microparticles are heated from about room temperature in an air atmosphere, the temperature at which the mass of the resin microparticles is reduced by 3% is 290° C. or higher. The resin microparticles exhibiting such properties have very excellent heat resistance.

Regarding the method for measuring the 3% decomposition temperature in an air atmosphere, for example, a method described in examples below can be used.

### (3% Decomposition Temperature in Inert Gas Atmosphere)

The resin microparticles of the present invention have a 3% decomposition temperature in an inert gas atmosphere that is preferably 340° C. or higher.

The 3% decomposition temperature in an inert gas atmosphere means that, when the resin microparticles are heated from about room temperature in an inert gas atmosphere, the temperature at which the mass of the resin microparticles is reduced by 3% is 340° C. or higher. The resin microparticles exhibiting such properties have very excellent heat resistance. Examples of inert gas atmospheres include one or more selected from the group consisting of a nitrogen gas, a carbon dioxide gas, and a rare gas (argon gas, neon gas, and helium gas).

As the method for measuring the 3% decomposition temperature in an inert gas atmosphere, for example, a method described in examples below can be used.

### (Amount of Surfactant Residues)

The amount of surfactant residues in the resin microparticles is the amount of the surfactant remaining in the resin microparticles based on a total amount of 100 mass % of the resin microparticles. The amount of surfactant residues in the resin microparticles is not particularly limited, and appropriately set according to the purpose and application, and is, for example, 1 mass % or less, preferably 0.7 mass % or less, more preferably 0.5 mass % or less, and 0 mass % or more. If no surfactant is used when resin microparticles are produced or raw materials are prepared, the amount of surfactant residues in the resin microparticles can be reduced to 0 mass % based on 100 mass % of the resin microparticles. When a surfactant is used when resin microparticles are polymerized, if the amount of surfactant residues exceeds 1 mass %, there is a risk of foaming or bleeding out occurring when the resin microparticles are dispersed in a medium.

Regarding the method for measuring the amount of surfactant residues, for example, a method described in examples below can be used.

### <Resin Microparticle Granules>

The resin microparticles of the present invention can be made into resin microparticle granules by aggregating a plurality of particles.

The resin microparticle granules can be classified as necessary to make the particle size uniform. Classification can be performed by a known means.

The volume average primary particle size of the resin microparticle granules is not particularly limited, and is, for example, 5 μm or more, and preferably 10 μm or more, and for example, 200 μm or less, and preferably 100 μm or less.

The obtained resin microparticle granules may be crushed to form resin microparticles. Examples of crushing methods include a dry crushing method using a mechanical grinder such as a blade mill, a super rotor, and a hammer mill and an air flow grinder such as a nano grinding mill (jet mill), and a wet crushing method using a bead mill, a ball mill and the like. The resin microparticles that are crushed and dispersed may have favorable dispersibility in a solvent.

### <Applications of Resin Microparticles>

The resin microparticles of the present invention are made of a general-purpose material, exhibit both high monodispersity and excellent heat resistance, and have a small volume average primary particle size, excellent transparency, and a narrow particle size distribution. Taking advantage of such properties, the resin microparticles of the present invention can be used for various applications. Examples of applications include anti-sticking agents (anti-blocking agents) for resin molded products (resin films), modifying agents for various resin molded products, optical members such as a light diffusion component and an anti-glare and low-reflection component, paint additives, spacer applications between micro parts of various electronic devices, pore forming agents for various battery members, and core particles of conductive microparticles that are responsible for electrical connection.

For example, the resin microparticles themselves can be mixed with a resin as an anti-sticking agent (anti-blocking agent) for a resin film to form a resin composition, and a resin molded product such as a film can be formed. Particularly, the resin microparticles of the present invention have excellent heat resistance and transparency, a narrow particle size distribution, and a small particle size, so that, even if the amount added is increased when a film-forming resin composition is prepared, it is possible to reduce the effect on the film haze and the like. In addition, the generation of resin scum caused by a thermal load and the like applied during resin compounding is curbed and there is little risk of the yield deteriorating.

When the resin microparticles are used as an anti-sticking agent for a resin film, particularly an anti-sticking agent for a resin film for optical applications, it is possible to stably produce optical members with high transparency, for example, optical films and light diffusion components such as an anti-glare film and a light diffusion film.

### [Method for Producing Resin Microparticles]

A method for producing resin microparticles of the present invention is a method for producing resin microparticles including a process of heating a mixture of polymer particles obtained by polymerizing monomer components, and an antioxidant or an antioxidant dispersing liquid in an aqueous medium, and the monomer components include a monofunctional (meth)acrylic-based monomer or a monofunctional aromatic vinyl-based monomer.

In the method for producing resin microparticles of the present invention, the temperature during the heat treatment may be equal to or higher than a melting point of the antioxidant and 120° C. or lower.

In the method for producing resin microparticles of the present invention, the polymer particles may be polymer particles obtained by seed polymerization, emulsion polymerization or soap-free polymerization.

In the method for producing resin microparticles of the present invention, the polymer particles may be polymer particles polymerized in the absence of a water-soluble polymer.

The method for producing resin microparticles of the present invention may further include a process of granulating and drying the resin microparticles.

The method for producing resin microparticles of the present invention may further include a process of dry-classifying and/or wet-classifying the resin microparticles.

### <Monomer Components>

The monomer components used in the method for producing resin microparticles of the present invention include one or more selected from the group consisting of monofunctional (meth)acrylic-based monomers and monofunctional aromatic vinyl-based monomers.

As the monofunctional (meth)acrylic-based monomers, the same monomers as those described in the section (Monofunctional (meth)acrylic-based Monomers) in <Vinyl-based Monomers> in [Resin Microparticles] can be used.

As the monofunctional aromatic vinyl-based monomers, the same monomers as those described in the section (Monofunctional Aromatic Vinyl-based Monomers) in <Vinyl-based Monomers> in [Resin Microparticles] can be used.

When monofunctional (meth)acrylic-based monomers are contained, the content thereof is not particularly limited. The content based on a total amount of 100 mass % of the monomer components is in a range of, for example, 10 mass % or more, and preferably 15 mass % or more, and for example, 90 mass % or less, and preferably 85 mass % or less.

When monofunctional aromatic vinyl-based monomers are contained, the content thereof is not particularly limited. The content based on a total amount of 100 mass % of the monomer components is in a range of, for example, 5 mass % or more, and preferably 10 mass % or more, and for example, 70 mass % or less, and preferably 60 mass % or less.

The monomer components used in the method for producing resin microparticles of the present invention may include a monomer component other than the monofunctional (meth)acrylic-based monomer or the monofunctional aromatic vinyl-based monomer. Examples of such monomer components include one or more monomers selected from the group consisting of multifunctional (meth)acrylic-based monomers, multifunctional aromatic vinyl-based monomers, hydrolyzable silyl group-containing vinyl-based monomers, fatty acid vinyl ester-based monomers, halogenated olefin-based monomers, cyanide vinyl-based monomers, unsaturated carboxylic acid-based monomers, unsaturated polycarboxylate-based monomers, unsaturated carboxylic acid amide-based monomers, unsaturated carboxylic acid amide methylolated component-based monomers, multifunctional aromatic hydrocarbon-based monomers, and multifunctional allyl-based monomers. It is preferable to contain one or more monomers selected from the group consisting of multifunctional (meth)acrylic-based monomers, multifunctional aromatic vinyl-based monomers, and hydrolyzable silyl group-containing vinyl-based monomers.

As specific examples of these monomer components, the same monomer components as those described in the section <Vinyl-based Monomers> in [Resin Microparticles] can be used.

The monomer components used in the method for producing resin microparticles of the present invention may further contain one or more selected from the group consisting of a thiol compound which is a multifunctional thiol compound and/or a monofunctional thiol compound having an alkyl group having 1 to 9 carbon atoms in the molecule, a non-crosslinkable polymer component made of a monomer component containing a (meth)acrylic acid ester-based monomer or an aromatic vinyl-based monomer, a photodegradation prevention agent, an ultraviolet absorbing agent (triazine-based compound), a heat fusion inhibitor (silica particles, etc.), a light diffusibility imparting agent (alumina particles, metal particles, etc.), a heat dissipation imparting agent (alumina particle, metal particles, etc.), and a colorant.

As specific examples thereof, the same as those described in the section <Vinyl-based Monomers> in [Resin Microparticles] can be used.

### <Polymerization Method>

In the method for producing resin microparticles of the present invention, the polymerization method for obtaining polymer particles by polymerizing monomer components is not particularly limited. Examples thereof include known polymerization methods such as suspension polymerization, seed polymerization, swelling seed polymerization, seed emulsion polymerization, emulsion polymerization, soap-free polymerization, mini-emulsion polymerization, microemulsion polymerization, solution polymerization and dispersion polymerization. Among these, it is preferable to use methods such as seed polymerization, emulsion polymerization, soap-free polymerization, and dispersion polymerization because these methods allow resin microparticles with a uniform particle size distribution to be obtained.

Seed polymerization is a method in which polymer microparticles obtained by polymerizing monomers are used as seed particles, the seed particles are made to absorb monomers in a medium, the seed particles are swollen with the monomers, and the monomers are then polymerized within the seed particles. In the seed polymerization, the seed particles can be grown to obtain resin microparticles having a larger particle size than the original seed particles.

Emulsion polymerization is a polymerization method in which an aqueous medium, monomers that are poorly soluble in the medium, and a surfactant (emulsifying agent) are mixed, and a polymerization initiator that is soluble in the aqueous medium is added to the mixture to cause polymerization. In the emulsion polymerization, the variation of the particle sizes of the obtained resin microparticles is small.

Soap-free polymerization is a method in which an aqueous medium and monomers that are poorly soluble in the medium are mixed in the absence of a surfactant (emulsifying agent), and a polymerization initiator that is soluble in the aqueous medium is added to the mixture to cause polymerization. Polymerization in which a material having a copolymerizable reactive group is added as an auxiliary emulsifying agent in the polymerization procedure, and in the dispersion component after polymerization, the auxiliary emulsifying agent component present in the aqueous medium is substantially absent is sometimes called soap-free polymerization. Soap-free polymerization is known as a clean polymerization method because the obtained polymer does not contain a component such as a surfactant.

Dispersion polymerization is a method in which monomers are dispersed in a polymerization solvent which may contain a dispersion stabilizer, and a polymerization initiator is added to polymerize the monomers. In order to prevent particles from adhering to each other during polymerization, it is preferable to perform polymerization under stirring by emitting ultrasonic waves and/or perform polymerization under stirring by a mechanical stirring device such as a magnetic stirrer. In the dispersion polymerization, it is easy to control the particle size and it is easy to obtain resin microparticles.

In the present invention, a method for obtaining resin microparticles by seed polymerization, emulsion polymerization, or soap-free polymerization is preferably used.

### (Seed Polymerization)

When resin microparticles of the present invention are prepared by seed polymerization, it is necessary to first obtain seed particles having a substantially uniform particle size and then grow these seed particles substantially uniformly.

Seed particles having a substantially uniform particle size as the raw material can be prepared by polymerization using polymerization methods such as suspension polymerization, soap-free emulsion polymerization (emulsion polymerization without using a surfactant), emulsion polymerization and dispersion polymerization. Among these, soap-free emulsion polymerization, emulsion polymerization, and dispersion polymerization are preferably used.

When seed particles are polymerized, a surfactant can be used as necessary. The surfactant is not particularly limited, and one or more of an anionic surfactant and/or a nonionic surfactant can be used. As the anionic surfactant and/or the nonionic surfactant, the same anionic surfactant and nonionic surfactant among surfactants described in the section (Surfactant) below can be used.

The amount of the surfactant used based on a total amount of 100 mass % of all monomers used for obtaining seed particles may be in a range of, for example, 0 mass % or more and 2 mass % or less.

When seed particles are polymerized, a polymerization initiator can be used as necessary. The polymerization initiator is not particularly limited, and preferably, one or more water-soluble radical polymerization initiators can be used. As the polymerization initiator, the same water-soluble radical polymerization initiator among polymerization initiators described in the section (Polymerization Initiator) below can be used.

The amount of the polymerization initiator used may be in a range of, for example, 0.1 mass % or more and 2 mass % or less, based on a total amount of 100 mass % of all monomers used for obtaining the seed particles. When the amount is less than 0.1 mass %, since the reaction rate is slow, the efficiency is poor, and when the amount is more than 2 mass %, there is a risk of the amount of initiator residues becoming excessive.

In the polymerization for obtaining seed particles, a molecular weight adjusting agent may be used to adjust the weight average molecular weight of the obtained seed particles. As the molecular weight adjusting agent, for example, mercaptans such as n-octyl mercaptan and tert-dodecyl mercaptan; α-methyl styrene dimer; terpenes such as γ-terpinene and dipentene; and halogenated hydrocarbons such as chloroform and carbon tetrachloride can be used. When the amount of the molecular weight adjusting agent used is adjusted, the weight average molecular weight of the obtained seed particles can be adjusted.

The volume average primary particle size of the seed particles can be appropriately adjusted depending on a desired average particle size of resin microparticles, and is preferably in a range of 0.01 μm or more and 1 μm or less.

In the seed polymerization, first, seed particles are added to an emulsified liquid containing monomers and an aqueous medium. The emulsified liquid can be prepared by a known method. For example, an emulsified liquid can be obtained by adding monomers to an aqueous medium, and dispersing the monomers using a microemulsifier such as a homogenizer, an ultrasonic processing machine, or a Nanomizer (registered trademark).

The seed particles may be added to the emulsified liquid without change, or may be added to the emulsified liquid in a form in which they are dispersed in an aqueous medium. After the seed particles are added to the emulsified liquid, the monomers are absorbed into the seed particles. This absorption can be generally performed by stirring the emulsified liquid at room temperature (25° C.) for a time of 1 hour or longer and 12 hours or shorter. In addition, in order to promote absorption of the monomers into the seed particles, as necessary the emulsified liquid may be heated to about 20° C. or higher and 50° C. or lower.

The seed particles swell by absorbing the monomers. The mixing ratio of the monomers and the seed particles is not particularly limited. For example, the proportion of the monomers based on 1 part by mass of the seed particles is preferably, for example, in a range of 1 part by mass or more, and preferably 5 parts by mass or more, and for example, 100 parts by mass or less, and preferably 50 parts by mass or less. When the mixing proportion of the monomers based on 1 part by mass of the seed particles is less than 1 part by mass, there is a risk of an increase in particle size due to polymerization decreasing, and there is a risk of the production efficiency decreasing. On the other hand, when the mixing proportion of the monomers based on 1 part by mass of the seed particles exceeds 100 parts by mass, there is a risk of the monomers not being completely absorbed into the seed particles and undergoing emulsion polymerization uniquely in an aqueous medium, and there is a risk of unintended resin microparticles with an unusual particle size being generated. Here, the completion of absorption of the monomers into the seed particles can be determined by confirming an increase in particle size by observation under an optical microscope.

Next, the monomers absorbed into the seed particles can be polymerized to obtain a resin microparticle dispersing liquid. When a process of absorbing monomers into seed particles and polymerizing them is repeated a plurality of times, a resin microparticle dispersing liquid may be obtained.

During seed polymerization, when the monomers absorbed into the seed particles are polymerized, a polymerization initiator can be added. After the polymerization initiator is mixed with the monomers, the obtained mixture may be dispersed in an aqueous medium, or the polymerization initiator and the monomers may be separately dispersed in aqueous media and then mixed.

The amount of the polymerization initiator added when the monomers are polymerized during seed polymerization may be more than 0 mass % and 3 mass % or less based on a total amount of 100 mass % of all monomers absorbed into the seed particles. As the polymerization initiator to be added, polymerization initiators described in the section (Polymerization Initiator) below can be used.

A dispersion stabilizer can be added during seed polymerization. Examples of dispersion stabilizers include anionic surfactants, nonionic surfactants, cationic surfactants, amphoteric surfactants, colloidal silica and the like described in the section (Surfactant) below. During seed polymerization, generally, one or more water-soluble polymers such as polyvinyl alcohol resins or polyvinylpyrrolidone resins are often used. On the other hand, in the present invention, since an embodiment in which resin microparticles are used at a high temperature is also assumed, it is preferable not to use a water-soluble polymer. In the present invention, as a dispersion stabilizer, it is preferable to use one or more of anionic surfactants and nonionic surfactants, and it is more preferable to use one or more of anionic reactive surfactants and nonionic reactive surfactants.

The amount of the dispersion stabilizer added during seed polymerization based on a total amount of 100 mass % of all monomers absorbed into the seed particles may be 0.3 mass % or more and 15 mass % or less. As the dispersion stabilizer that can be added during seed polymerization, surfactants described in the section (Surfactant) below can be used.

The polymerization temperature during seed polymerization can be appropriately selected depending on the type of the monomers and the type of the polymerization initiator used as necessary, and may be, for example, 25° C. or higher, and preferably 50° C. or higher, and for example, 110° C. or lower, and preferably 100° C. or lower.

The polymerization time during seed polymerization can be appropriately selected depending on the type of the monomers and the type of the polymerization initiator used as necessary, and may be, for example, 1 hour or longer and 12 hours or shorter.

The atmosphere during seed polymerization is preferably an atmosphere of a gas (for example, nitrogen) that is inert to the polymerization.

In the seed polymerization, it is preferable to perform heating after the monomers and the polymerization initiator used as necessary are completely absorbed into the seed particles.

In the seed polymerization, in order to curb the generation of emulsion polymerization products (resin microparticles having a very small particle size) in the aqueous medium during the reaction, nitrites such as sodium nitrite, and water-soluble polymerization inhibitors such as sulfites, hydroquinone, ascorbic acid, citric acid, and polyphenols may be added to the aqueous medium.

The amount of the polymerization inhibitor added during seed polymerization based on a total amount of 100 mass % of all monomers absorbed into the seed particles may be, for example, 0.002 mass % or more and 0.2 mass % or less.

### <Components Used During Polymerization>

In the method for producing resin microparticles of the present invention, when monomer components are polymerized to obtain polymer particles, as necessary, a polymerization initiator, a surfactant (emulsifying agent), a dispersing agent and the like can be used as components used during polymerization.

### (Polymerization Initiator)

In the method for producing resin microparticles of the present invention, the polymerization initiator used when monomer components are polymerized to obtain polymer particles are not particularly limited, and one or more selected from the group consisting of oil-soluble polymerization initiators and water-soluble polymerization initiators can be used.

In the case of seed polymerization or suspension polymerization, it is preferable to use a thermally decomposable oil-soluble polymerization initiator, and in the case of seed emulsion polymerization, emulsion polymerization, or soap-free polymerization, it is preferable to use a thermally decomposable water-soluble polymerization initiator.

As the polymerization initiator for preparing resin microparticles of the present invention, it is preferable to use a radical polymerization initiator, particularly, a thermal polymerization initiator.

Among the polymerization initiators, examples of oil-soluble polymerization initiators include one or more selected from the group consisting of organic peroxides such as cumene hydroperoxide, di-tert-butyl peroxide, dicumyl peroxide, benzoyl peroxide, lauroyl peroxide, dimethylbis(tert-butylperoxy)hexane, dimethylbis(tert-butylperoxy)hexyne-3, bis(tert-butylperoxyisopropyl)benzene, bis(tert-butylperoxy)trimethylcyclohexane, butyl-bis(tert-butylperoxy)valerate, tert-butyl 2-ethylhexaneperoxyacid, dibenzoyl peroxide, paramenthane hydroperoxide and tert-Butyl peroxybenzoate; and nitrile-azo compounds such as 2,2′-azobisisobutyronitrile, 2,2′-azobis(2-methylbutyronitrile), 2,2′-azobis(2-isopropylbutyronitrile), 2,2′-azobis(2,3-dimethylbutyronitrile), 2,2′-azobis(2,4-dimethylbutyronitrile), 2,2′-azobis(2-methylcapronitrile), 2,2′-azobis(2,3,3-trimethylbutyronitrile), 2,2′-azobis(2,4,4-trimethylvaleronitrile), 2,2′-azobis(2,4-dimethylvaleronitrile), 2,2′-azobis(4-methoxy-2,4-dimethylvaleronitrile), 2,2′-azobis(4-ethoxy-2,4-dimethylvaleronitrile), 2,2′-azobis(4-n-butoxy-2,4-dimethylvaleronitrile), 1,1′-azobis(cyclohexane-1-carbonitrile), 2-(carbamoylazo)isobutyronitrile, and 4,4′-azobis(4-cyanopentanoic acid).

Among the polymerization initiators, examples of water-soluble polymerization initiators include one or more selected from the group consisting of persulfates (for example, ammonium persulfate, potassium persulfate, sodium persulfate, etc.), hydrogen peroxide, organic peroxides, and water-soluble azo compounds. Examples of water-soluble azo compounds include one or more selected from the group consisting of 2,2′-azobis[2-methyl-N-(2-hydroxyethyl)propionamide], 4,4′-azobis(4-cyanovaleric acid), 2,2′-azobis[N-(2-carboxyethyl)-2-methylpropionamidine]n-hydrate, 2,2′-azobis[2-(2-imidazolin-2-yl)propane], and 2,2′-azobis[2-(2-imidazolin-2-yl)propane]dihydrochloride.

In addition, a redox polymerization initiator in which one or more selected from the group consisting of polymerization initiators such as persulfates and organic peroxides described above and one or more reducing agents selected from the group consisting of sodium sulfoxylate formaldehyde, sodium bisulfite, ammonium bisulfite, sodium thiosulfate, ammonium thiosulfate, hydrogen peroxide, sodium hydroxymethanesulfinate, L-ascorbic acid and its salts, cuprous salts, and ferrous salts are combined may be used.

In the present invention, as the oil-soluble polymerization initiator, it is preferable to use one or more selected from the group consisting of 2,2′-azobisisobutyronitrile, 2,2′-azobis(4-methoxy-2,4-dimethylvaleronitrile), 2,2′-azobis(2,4-dimethylvaleronitrile), 2,2′-azobisisobutyronitrile, 2,2′-azobis(2-methylbutyronitrile), 1,1′-azobis(cyclohexane-1-carbonitrile), 4,4′-azobis(4-cyanopentanoic acid), cumene hydroperoxide, di-tert-butyl peroxide, dicumyl peroxide, benzoyl peroxide, and lauroyl peroxide.

In the present invention, as the water-soluble polymerization initiator, it is preferable to use one or more selected from the group consisting of potassium persulfate, ammonium persulfate, 2,2′-azobis[2-methyl-N-(2-hydroxyethyl)propionamide], 4,4′-azobis(4-cyanovaleric acid), 2,2′-azobis[N-(2-carboxyethyl)-2-methylpropionamidine]n-hydrate, 2,2′-azobis[2-(2-imidazolin-2-yl)propane], and 2,2′-azobis[2-(2-imidazolin-2-yl)propane]dihydrochloride.

These polymerization initiators may be used alone or two or more thereof may be used in combination.

The amount of the polymerization initiator used can be appropriately determined depending on the type thereof and is not particularly limited, and is in a range of, for example, 0.1 parts by mass or more, and preferably 0.3 parts by mass or more, and for example, 5 parts by mass or less, and preferably 3 parts by mass or less, based on 100 parts by mass of all monomers used in the polymerization.

### (Surfactant)

In the method for producing resin microparticles of the present invention, the surfactant used when monomer components are polymerized to obtain polymer particles is not particularly limited, and one or more selected from the group consisting of anionic surfactants, cationic surfactants, amphoteric surfactants and nonionic surfactants can be used.

Examples of anionic surfactants include one or more of an anionic non-reactive surfactant and an anionic reactive surfactant.

Examples of anionic non-reactive surfactants include one or more selected from the group consisting of sodium oleate; fatty acid soaps such as castor oil potash soap; alkyl sulfate ester salts such as sodium lauryl sulfate and ammonium lauryl sulfate; alkylbenzene sulfonate such as sodium dodecylbenzenesulfonate; alkylnaphthalenesulfonate; alkanesulfonate; dialkyl sulfosuccinate; alkyl phosphate ester salts; naphthalene sulfonic acid formalin condensates; polyoxyethylene alkyl phenyl ether sulfate ester salts; polyoxyethylene sulfonated phenyl ether phosphate; and polyoxyethylene alkyl sulfate ester salts.

Examples of anionic reactive surfactants include one or more selected from the group consisting of styrene sulfonate-based metal salts such as Spinomar (registered trademark) Nass (commercially available from Tosoh Finechem Corporation); ELEMINOL (registered trademark) JS-20 and RS-3000 (commercially available from Sanyo Chemical Industries, Ltd.); Antox MS-60 (commercially available from Nippon Nyukazai Co., Ltd.); Aqualon (registered trademark) KH-10, KH-1025, KH-05, HS-10, HS-1025, BC-0515, BC-10, BC-1025, BC-20, BC-2020, AR-1025, and AR-2025 (commercially available from DKS Co., Ltd.); Latemul (registered trademark) S-120, S-180A, S-180, PD-104, PD-105, and ASK (commercially available from Kao Corporation); and Adeka Reasoap (registered trademark) SR-1025, and SE-10N (commercially available from ADEKA).

Examples of nonionic surfactants include one or more of a nonionic non-reactive surfactant and a nonionic reactive surfactant.

Examples of nonionic non-reactive surfactants include one or more selected from the group consisting of polyoxyalkylene branched decyl ether, polyoxyethylene tridecyl ether, polyoxyalkylene alkyl ether, polyoxyalkylene tridecyl ether, polyoxyethylene isodecyl ether, polyoxyalkylene lauryl ether, polyether polyol, polyoxyethylene styrenated phenyl ether, polyoxyethylene naphthyl ether, polyoxyethylene phenyl ether, polyoxyethylene polyoxypropylene glycol, polyoxyethylene lauryl ether, polyoxyethylene oleyl cetyl ether, polyoxyethylene glyceryl isostearate, polyoxyethylene alkyl ether, polyoxyethylene alkyl phenyl ether, polyoxyethylene fatty acid ester, sorbitan fatty acid ester, polyoxysorbitan fatty acid ester, polyoxyethylene alkylamine, glycerin fatty acid ester, and oxyethylene-oxypropylene block polymers.

Examples of nonionic reactive surfactants include one or more selected from the group consisting of alkyl ether surfactants (commercially available products, for example, Adeka Reasoap (registered trademark) ER-10, ER-20, ER-30, and ER-40, commercially available from ADEKA); Latemul (registered trademark) PD-420, PD-430, and PD-450 (commercially available from Kao Corporation)); alkyl phenyl ether-based or alkyl phenyl ester-based surfactants (commercially available products for example, Aqualon (registered trademark) RN-10, RN-20, RN-30, RN-50, AN-10, AN-20, AN-30, and AN-5065 (commercially available from DKS Co., Ltd.); Adeka Reasoap (registered trademark) NE-10, NE-20, NE-30, and NE-40 (commercially available from ADEKA)); and (meth)acrylate sulfate-based surfactants (commercially available products, for example, RMA-564, RMA-568, and RMA-1114 (commercially available from Nippon Nyukazai Co., Ltd.)).

Examples of cationic surfactants include one or more selected from the group consisting of alkylamine salts such as laurylamine acetate and stearylamine acetate; and quaternary ammonium salts such as lauryltrimethylammonium chloride.

Examples of amphoteric surfactants include one or more selected from the group consisting of lauryl dimethylamine oxide and lauryl aminoacetate betaine.

These surfactants may be used alone or two or more thereof may be used in combination. The type of the surfactant is appropriately selected and the amount of the surfactant used is appropriately adjusted in consideration of the particle size of the obtained resin microparticles, the dispersion stability of monomers during polymerization and the like.

In the present invention, it is preferable to use one or more of anionic surfactants and nonionic surfactants, and it is more preferable to use one or more of anionic reactive surfactants and nonionic reactive surfactants.

The amount of the surfactant used is not particularly limited. The amount based on 100 parts by mass of all monomers used in the polymerization may be in a range of, for example, 0.01 parts by mass or more, preferably 0.05 parts by mass or more, and more preferably 0.1 parts by mass or more, and for example, 10 parts by mass or less, preferably 8 parts by mass or less, and more preferably 5 parts by mass or less.

### (Polymerization Medium)

In the method for producing resin microparticles of the present invention, the polymerization medium used when monomer components are polymerized to obtain polymer particles is not particularly limited, and one or more selected from the group consisting of an aqueous medium and an organic medium (organic solvent) can be used. In the method for producing resin microparticles of the present invention, it is preferable to use an aqueous medium.

As the aqueous medium, for example, water alone, a water-soluble organic solvent such as a lower alcohol having 5 or less carbon atoms such as methyl alcohol, ethyl alcohol, and isopropyl alcohol, and a water/water-soluble organic solvent mixture such as a mixture of water and the lower alcohol can be used. Water alone or a water/water-soluble organic solvent mixture of water and a lower alcohol (methanol, ethanol, isopropyl alcohol, etc.) is preferable, and in consideration of a wastewater treatment, water alone is preferable.

The amount of the aqueous medium used is not particularly limited. The amount based on 100 parts by mass of all monomers used in the polymerization may be in a range of, for example, 200 parts by mass or more, and preferably 300 parts by mass or more, and for example, 2,000 parts by mass or less, and preferably 1,500 parts by mass or less. When the amount of the aqueous medium used is set to equal to or more than the lower limit of the above range, it is possible to maintain the stability of monomer particles during polymerization and curb the generation of aggregates of resin microparticles after polymerization. When the amount of the aqueous medium used is set to the upper limit or less, the productivity tends to be favorable.

### <Antioxidant or Antioxidant Dispersing Liquid>

The antioxidant used in the method for producing resin microparticles of the present invention may be the same as that described in the section <Antioxidant> in [Resin Microparticles].

The antioxidant dispersing liquid used in the method for producing resin microparticles of the present invention may be a dispersing liquid obtained by mixing an antioxidant with one or more media selected from the group consisting of an aqueous medium and an organic medium (organic solvent). The aqueous medium and organic medium (organic solvent) used may be the same as those described in the section (Polymerization Medium) in <Components Used During Polymerization>. In the method for producing resin microparticles of the present invention, the antioxidant dispersing liquid is preferably one obtained by dispersing an antioxidant in an aqueous medium.

### <Aqueous Medium>

In the method for producing resin microparticles of the present invention, the aqueous medium used when a mixture of polymer particles and an antioxidant or an antioxidant dispersing liquid is heated is not particularly limited. For example, the same aqueous media described in the section (Polymerization Medium) in <Components Used During Polymerization> can be used. For example, an aqueous medium contained in the antioxidant dispersing liquid can be used.

In addition, the amount of the aqueous medium used is not particularly limited. For example, the amount of the aqueous medium used may be the same as that described in the section (Polymerization Medium) in <Components Used During Polymerization>.

### <Heat Treatment>

In the method for producing resin microparticles of the present invention, the heat temperature when the mixture of polymer particles and an antioxidant or an antioxidant dispersing liquid is heated is not particularly limited as long as it is a temperature at which the polymer particles and the antioxidant are not thermally decomposed. The temperature may be, for example, 30° C. or higher, and preferably equal to or higher than the melting point of the antioxidant, and may be, for example, equal to or lower than the thermal decomposition temperature of the antioxidant, and preferably 120° C. or lower.

### <Washing, Drying and Crushing of Resin Microparticles>

After polymerization is completed, the resin microparticles can be washed, dried, crushed, and classified as necessary according to desired applications. For example, after polymerization is completed, a cake containing an aqueous medium (a water-containing cake) is obtained by a method such as suction filtration, centrifugation, or pressure separation, subjected to a washing process using water and/or a solvent as necessary, then dried in a drying process, and subjected to a crushing process and a classification process as necessary, and can be isolated as a dry powder.

### (Washing)

The washing method in the washing process is not particularly limited. For example, the aqueous dispersion component obtained after polymerization can be subjected to centrifugal washing, cross-flow filtration washing or the like. In addition, after the cake is formed, it can be immersed in water and/or a solvent and then dehydrated. Here, when a reactive emulsifier is used, washing of the aqueous dispersion component obtained after polymerization can be omitted. In this case, the amount of surfactant residues in the resin microparticles (methanol extraction-LC/MS/MS method) is preferably 1 mass % or less and more preferably 0.5 mass % or less.

### (Drying and Crushing)

The drying method in the drying process is not particularly limited. For example, a vacuum (decompressed) oven, a spray drying method using a spray dryer, a freeze-drying method, a drying method for adhesion to a heated rotating drum such as a drum dryer and the like can be used.

The drying process may be a process of granulating and drying the resin microparticles.

The method for granulating and drying resin microparticles is not particularly limited. For example, a resin microparticle slurry obtained in a monomer polymerization process can be granulated and dried using a granulating and drying means such as spray drying or freeze-granulating drying.

In the spray drying, for example, a spray dryer in which the inlet temperature of the resin microparticle slurry is 80° C. or higher and 220° C. or lower, and the outlet temperature of the resin microparticle granules is 50° C. or higher and 100° C. or lower can be used. The obtained resin microparticle granules may have better handling properties than the resin microparticles themselves.

When the resin microparticles are granulated or aggregated after the drying process, a crushing process can be performed. The crushing method in the crushing process is not particularly limited. For example, a crushing method using a jet mill, a hammer mill, a bead mill, a mixer or the like can be used.

<Dry Classification and/or Wet Classification>

The method for producing resin microparticles of the present invention may further include a process of dry-classifying and/or wet-classifying the resin microparticles.

The classification method in the dry classification and/or wet classification process is not particularly limited. For example, the resin microparticles or granules can be classified by a known means using a sieve, a net, a non-woven filter, centrifugation, air classification or the like.

In the method for producing resin microparticles of the present invention, the resin microparticles are preferably wet-classified using a filter with a desired absolute filtration accuracy, for example, an absolute filtration accuracy of 5 μm or less.

### EXAMPLES

Hereinafter, the present invention will be described in more detail with reference to production examples, examples and comparative examples. Here, the present invention is not limited thereto.

### [Measurement Method]

“Volume average primary particle size,” “coefficient of variation of the volume average primary particle size,” “silicon element content,” “3% decomposition temperature in an air atmosphere,” “3% decomposition temperature in an inert gas atmosphere” and “amount of surfactant residues” of resin microparticles were measured as follows.

### <Volume Average Primary Particle Size>

The volume average primary particle size of the resin microparticles was measured and calculated by evaluation using a laser diffraction/scattering type particle size distribution measurement device (“LS 13 320,” commercially available from Beckman Coulter, Inc.) and a universal liquid sample module.

0.1 g of a resin microparticle aqueous dispersing liquid (a solid content of 20%) and 20 ml of a 2 mass % anionic surfactant solution were put into a test tube. Then, the mixture was dispersed using a test tube mixer (“test tube mixer TRIO HM-1N,” commercially available from As One Corporation) and an ultrasonic cleaner (“ULTRASONIC CLEANER VS-150,” commercially available from As One Corporation) for 5 minutes to obtain a resin microparticle dispersing liquid. While ultrasonic waves were emitted to the obtained dispersing liquid, the volume-based particle size distribution of the resin microparticles and the standard deviation thereof were obtained using a laser diffraction/scattering type particle size distribution measurement device (“LS230,” commercially available from Beckman Coulter, Inc.). The arithmetical mean of the volume-based particle size distribution was used as a volume average primary particle size of the resin microparticles.

The measurement conditions for the laser diffraction/scattering type particle size distribution measurement device were as follows.
Medium=water
Refractive index of medium=1.333
Refractive index of solid=refractive index of resin microparticles
PIDS relative concentration: 40 to 55%

An optical model used in the measurement was adjusted according to the refractive index of the produced resin microparticles. The refractive index of the resin microparticles was determined as an average value obtained by weighted-averaging the refractive indexes of homopolymers of monomers constituting the resin microparticles by the amount of the monomers used.

### <Coefficient of Variation of Volume Average Primary Particle Size>

The coefficient of variation of the volume average primary particle size of the resin microparticles was calculated by the following formula using the volume average primary particle size of the resin microparticles and the standard deviation of the volume-based particle distribution of the resin microparticles obtained when the volume average primary particle size of the resin microparticles was measured.

$$Coefficient of variation of the volume average primary particle size = [ ( standard deviation of the volume - based particle size distribution of the resin microparticles ) / ( volume average primary particle size of the resin microparticles ) ] \times 100$$

### <Silicon Element Content>

The silicon element content of the resin microparticles was determined by measuring the peak height of the silicon element by fluorescence X-ray spectrometry and determining the amount of the silicon element content by an order analysis method (FP bulk method). Specifically, using a fluorescent X-ray analysis device (ZSX Primus IV, commercially available from Rigaku Corporation), under the following device conditions and qualitative element conditions, the intensity of Si-Kα was measured, and the silicon element content in the resin microparticles was measured by the order analysis method. First, a conductive carbon double-sided tape (commercially available from Nisshin-EM) was attached to a carbon sample stand (commercially available from Nisshin-EM), 20 mg of a sample (resin microparticles produced in each example and comparative example) was weighed out on the attached conductive carbon double-sided tape, and adjustment was performed so that the sample did not spread beyond 10 mmφ. Then, the sample was covered with a polypropylene film (PP film) and set in a 10 mmφ sample case bundled in the device to prepare a measurement sample.

Next, the peak height of the silicon element was measured under the following conditions, and the amount of the silicon element content was determined by the order analysis method.

### <Device Conditions>

Device: ZSX Primus IV
X-ray tube target: Rh
Analysis method: order analysis method (FP bulk method)
Measurement diameter: 10 mm
Spin: yes
Atmosphere: vacuum
Sample form: metal
Balance component: CHO
Sample protection film correction: yes (PP film)
Smoothing: 11 points
Flux component, dilution rate, impurity removal: none

### <Qualitative Element Conditions>

Si-Kα
Tube: Rh (30 kV-100 mA)
Primary filter: OUT
Attenuator: 1/1
Slit: Std.
Analyzing crystal: Ge
20: 110.820 deg (measurement range: 107 to 114 deg)
Detector: PC
PHA L.L.: 150 U.L.: 300
Step: 0.05 deg
Time: 0.4 sec

### <3% Decomposition Temperature in Air Atmosphere>

The 3% decomposition temperature in an air atmosphere of the resin microparticles was measured using a simultaneous thermogravimetric and differential thermal analyzer (commercially available from SII NanoTechnology Inc., TG/DTA6200). The sample preparation method and measurement conditions were as follows.

### (Sample Preparation Method)

A sample was prepared by filling the bottom of a platinum measuring container with about 15 mg of resin microparticles (measurement sample) so that no gaps were left.

### (Measurement Conditions)

The air gas flow rate was set to 200 mL/min, and alumina was used as a reference substance. The sample was heated from 300° C. to 500° C. at 10° C./min to obtain a TG/DTA curve. The temperature at which the mass of the sample was reduced by 3% from the start of the measurement was determined from the obtained TG/DTA curve using analysis software bundled in the device and used as a 3% thermal decomposition temperature in an air atmosphere.

### <3% Decomposition Temperature in Inert Gas Atmosphere>

The 3% thermal decomposition temperature of the resin microparticles in an inert gas atmosphere was measured using a simultaneous thermogravimetric and differential thermal analyzer (TG/DTA6200, commercially available from SII NanoTechnology Inc.). The sample preparation method and measurement conditions were as follows.

### (Sample Preparation Method)

A sample was prepared by filling the bottom of a platinum measuring container with about 15 mg of resin microparticles (measurement sample) so that no gaps were left.

### (Measurement Conditions)

The nitrogen gas flow rate was set to 220 mL/min, and alumina was used as a reference substance. The sample was heated from 300° C. to 500° C. at 10° C./min to obtain a TG/DTA curve. The temperature at which the mass of the sample was reduced by 3% from the start of the measurement was determined from the obtained TG/DTA curve using analysis software bundled in the device and used as a 3% thermal decomposition temperature in an inert gas atmosphere.

### <Amount of Surfactant Residues>

The amount of surfactant residues could be determined, for example, by the following methanol extraction-LC/MS/MS method.

The resin microparticles were extracted with a solvent, and measurement was performed using a liquid chromatograph linear ion trap mass spectrometer (LC/MS/MS device).

As the LC/MS/MS device, “UHPLC ACCELA” (commercially available from Thermo Fisher Scientific) and “Linear Ion Trap LC/MSn LXQ” (commercially available from Thermo Fisher Scientific) could be used.

The amount of surfactant residues was measured by the following method.

About 0.01 g of resin microparticles was accurately weighed into a centrifuge tube, an extraction solution was then poured, the resin microparticles and the extraction solution were thoroughly mixed, the mixture was subjected to ultrasonic extraction, then mixed again, and centrifuged, and the obtained supernatant solution was filtered to prepare a test solution.

The concentration of the surfactant in the test solution was measured using the LC/MS/MS device, and the amount of surfactant residues was calculated from the peak area value on the obtained chromatogram using a calibration curve created in advance.

Here, the calibration curve creation method was as follows.

An intermediate standard solution (methanol solution) of the surfactant with a concentration of about 1,000 ppm was prepared, and then additionally gradually diluted with methanol to prepare a standard solution for calibration curve creation with a concentration of 20 ppm, 10 ppm, 5 ppm, and 2.5 ppm. The standard solution for calibration curve creation with each concentration was measured under the following conditions to obtain a peak area value on a chromatogram for monitor ions m/z=730 to 830. Each concentration and the area value were plotted, and an approximate curve (quadratic curve) was obtained by the least squares method, and this was used as a calibration curve for quantification.

Then, the amount of surfactant residues in the resin microparticles was calculated from the measured surfactant concentration in the test solution, the weight (sample weight) of the resin microparticles used as the sample, and the amount of the extraction solution according to the following calculation formula.

Amount of surfactant residues=the surfactant concentration in the test solution×the amount of the extraction solution+the sample weight

### PRODUCTION EXAMPLES

### Production Example 1

In a polymerization container including a stirring device, a thermometer and a cooling mechanism, 270 parts by mass of deionized water and 0.84 parts by mass of sodium styrene sulfonate were mixed to prepare an aqueous phase. 120 parts by mass of methyl methacrylate and 2.4 parts by mass of 1-octanethiol were mixed in a separate container, and the obtained mixture was then added to the aqueous phase in the polymerization container. After purging the polymerization container with nitrogen for 5 minutes, the temperature was raised to 80° C., and when the temperature reached 80° C., 0.6 parts by mass of potassium persulfate dissolved in 10 parts by mass of deionized water was added. Subsequently, purging with nitrogen was performed again for 5 minutes, and polymerization was performed by stirring at 80° C. for 5 hours. Then, the temperature was raised to 100° C. and maintained for 3 hours, and then cooled to prepare a resin microparticle-containing slurry. This was defined as a seed particle slurry A. The volume average primary particle size of the resin microparticles in the obtained seed particle slurry A was 178 nm.

### Production Example 2

In a reactor including a stirring device, a thermometer and a cooling mechanism, 57 parts by mass of deionized water, 3 parts by mass of sodium dodecylbenzenesulfonate and 40 parts by mass of ethylenebis(oxyethylene)bis[3-(5-tert-butyl-4-hydroxy-m-tolyl)propionate](a melting point of 79° C.) were mixed, stirred at 100° C. for 5 hours, and then slowly cooled to prepare an antioxidant dispersing liquid A.

### Production Example 3

In a polymerization container including a stirring device, a thermometer and a cooling mechanism, 270 parts by mass of deionized water and 0.84 parts by mass of sodium styrene sulfonate were mixed to prepare an aqueous phase. 120 parts by mass of methyl methacrylate and 2.4 parts by mass of 1-octanethiol were mixed in a separate container, and the obtained mixture was then added to the aqueous phase in the polymerization container. After purging the polymerization container with nitrogen for 5 minutes, the temperature was raised to 80° C., and when the temperature reached 80° C., 0.6 parts by mass of potassium persulfate dissolved in 10 parts by mass of deionized water was added. Subsequently, purging with nitrogen was performed again for 5 minutes, and polymerization was performed by stirring at 80° C. for 5 hours. Then, the temperature was raised to 100° C. and maintained for 3 hours, and then cooled, and 3 parts by mass of the antioxidant dispersing liquid A prepared in Production Example 2 was then added, the temperature was raised again to 100° C. and maintained for 2 hours and then cooled to prepare a resin microparticle-containing slurry with an antioxidant absorbed thereto. This was defined as a seed particle slurry B. The volume average primary particle size of the resin microparticles in the obtained seed particle slurry B was 178 nm.

### Production Example 4

In a reactor including a stirring device, a thermometer and a cooling mechanism, 77 parts by mass of deionized water, 3 parts by mass of sodium dodecylbenzenesulfonate and 20 parts by mass of 4-[[4,6-bis(octylthio)-1,3,5-triazin-2-yl]amino]-2,6-di-tert-butylphenol (a melting point of 96° C.) were mixed, stirred at 110° C. for 5 hours, and then slowly cooled to prepare an antioxidant dispersing liquid B.

### EXAMPLES AND COMPARATIVE EXAMPLES

### Example 1

In a polymerization container including a stirring device, a thermometer and a cooling mechanism, 270 parts by mass of deionized water and 1.4 parts by mass of ELEMINOL JS-20 (anionic reactive surfactant, an active component of 40%, commercially available from Sanyo Chemical Industries, Ltd.) were mixed to prepare an aqueous phase.

In a separate container, 35 parts by mass of butyl acrylate, 21 parts by mass of styrene, 14 parts by mass of ethylene glycol dimethacrylate, 0.4 parts by mass of pentaerythritol tetrakisthioglycolate and 1.3 parts by mass of 3-methacryloxypropyltrimethoxysilane (“KBE-503,” commercially available from Shin-Etsu Chemical Co., Ltd.) were thoroughly mixed to prepare an oil phase.

The oil phase was added to the aqueous phase in the polymerization container and stirred using a TK homomixer (commercially available from PRIMIX Corporation) at 8,000 rpm for 10 minutes to obtain a mixed monomer solution. 34 parts by mass of the seed particle slurry A prepared in Production Example 1 was added to the mixed monomer solution and stirred for 3 hours to make the mixture swell. In a separate container, 0.35 parts by mass of a polymerization initiator V-501 (commercially available from FUJIFILM Wako Pure Chemical Corporation) was dissolved in 5 parts by mass of ethanol and 5 parts by mass of deionized water heated to 30° C., and the solution was put into the polymerization container. Then, purging with nitrogen was performed for 5 minutes, the temperature was then heated to 70° C., and the mixture was stirred at 70° C. for 5 hours to cause a polymerization reaction.

In addition, the temperature was raised to 100° C. and maintained for 3 hours, and then cooled, 1.8 parts by mass of the antioxidant dispersing liquid A prepared in Production Example 2 was then added, the temperature was raised again to 100° C. and maintained for 2 hours, and then cooled to obtain a resin microparticle-containing slurry 1.

The resin microparticle-containing slurry 1 was passed through a 500 Mesh screen and then passed through a filter with an absolute filtration accuracy of 3 μm (KDGF-030, commercially available from Asahi Kasei Corporation) to obtain a classified resin microparticle-containing slurry 1.

The classified resin microparticle slurry 1 was sprayed and dried using a spray dryer (machine name: spray dryer, type: atomizer take-up type, model number: TRS-3WK, commercially available from Sakamoto Giken Co., Ltd.) under the following spray dryer conditions to obtain a dried product of resin microparticles E1.

### <Spray Dryer Conditions>

Supply rate of resin microparticle-containing slurry: 25 mL/min
Atomizer rotation speed: 12,000 rpm
Air volume: 2 m³/min
Inlet temperature (the temperature of the inlet provided in the spray dryer and through which the resin microparticle-containing slurry is sprayed and introduced): 120° C.
Outlet temperature (the temperature of the powder outlet provided in the spray dryer and from which resin microparticle granules are discharged): 70° C.

The obtained dried product of resin microparticles E1 exhibited the following properties.
Volume average primary particle size: 0.38 μm
Coefficient of variation of the volume average primary particle size (CV value): 14.6%
3% decomposition temperature in an air atmosphere: 320° C.
3% decomposition temperature in an inert gas atmosphere: 346° C.
Silicon element content in the resin microparticles measured by fluorescent X-ray analysis: 0.18 mass %
Amount of surfactant residues: less than the lower detection limit (ND: lower limit value 0.0002 mass %)

### Example 2

A dried product of resin microparticles E2 was obtained in the same manner as in Example 1 except that, in place of 1.4 parts by mass of ELEMINOL JS-20 (anionic reactive surfactant, an active component of 40%, commercially available from Sanyo Chemical Industries, Ltd.), 1.0 part by mass of Antox MS-60 (anionic reactive surfactant, commercially available from Nippon Nyukazai Co., Ltd.) was used as the surfactant. Table 1 shows the properties of the obtained dried product of resin microparticles E2.

### Example 3

A dried product of resin microparticles E3 was obtained in the same manner as in Example 1 except that, in place of 1.8 parts by mass of the antioxidant dispersing liquid A prepared in Production Example 2, 3.6 parts by mass of the antioxidant dispersing liquid B prepared in Production Example 4 was used as the antioxidant. Table 1 shows the properties of the obtained dried product of resin microparticles E3.

### Example 4

A dried product of resin microparticles E4 was obtained in the same manner as in Example 1 except that, in place of 34 parts by mass of the seed particle slurry A prepared in Production Example 1, 34 parts by mass of the seed particle slurry B prepared in Production Example 3 was used as the seed particle slurry, and 1.8 parts by mass of the antioxidant dispersing liquid A prepared in Production Example 2 was not added. Table 1 shows the properties of the obtained dried product of resin microparticles E4.

### Example 5

A dried product of resin microparticles E5 was obtained in the same manner as in Example 1 except that, in place of 34 parts by mass of the seed particle slurry A prepared in Production Example 1, 34 parts by mass of the seed particle slurry B prepared in Production Example 3 was used as the seed particle slurry. Table 1 shows the properties of the obtained dried product of resin microparticles E5.

### Example 6

In a polymerization container including a stirring device, a thermometer and a cooling mechanism, 270 parts by mass of deionized water, 0.6 parts by mass of sodium dodecylbenzenesulfonate and 0.7 parts by mass of Noigen EA-167 (nonionic surfactant, commercially available from DKS Co., Ltd.) were mixed to prepare an aqueous phase.

In a separate container, 35 parts by mass of butyl acrylate, 21 parts by mass of styrene, 14 parts by mass of ethylene glycol dimethacrylate, 0.4 parts by mass of pentaerythritol tetrakisthioglycolate, 1.3 parts by mass of 3-methacryloxypropyltrimethoxysilane (“KBE-503,” commercially available from Shin-Etsu Chemical Co., Ltd.) and 0.5 parts by mass of 2,2′-azobis(isobutyronitrile) were thoroughly mixed to prepare an oil phase.

The oil phase was added to the aqueous phase in the polymerization container and stirred using a TK homomixer (commercially available from PRIMIX Corporation) at 8,000 rpm for 10 minutes to obtain a mixed monomer solution. 34 parts by mass of the seed particle slurry A prepared in Production Example 1 was added to the mixed monomer solution and stirred for 3 hours to make the mixture swell. Then, purging with nitrogen was performed for 5 minutes, the temperature was then raised to 65° C., and the mixture was stirred at 65° C. for 6 hours to cause a polymerization reaction.

In addition, the temperature was raised to 100° C. and maintained for 3 hours, and then cooled, 1.8 parts by mass of the antioxidant dispersing liquid A prepared in Production Example 2 was then added, the temperature was raised again to 100° C., maintained for 2 hours and then cooled to obtain a resin microparticle-containing slurry 6.

The resin microparticle-containing slurry 6 was passed through a 500 Mesh screen and then passed through a filter with an absolute filtration accuracy of 3 μm (KDGF-030, commercially available from Asahi Kasei Corporation) to obtain a classified resin microparticle-containing slurry 6.

The classified resin microparticle slurry 6 was sprayed and dried using a spray dryer (machine name: spray dryer, type: atomizer take-up type, model number: TRS-3WK, commercially available from Sakamoto Giken Co., Ltd.) under the following spray dryer conditions to obtain a dried product of resin microparticles E6.

### <Spray Dryer Conditions>

Supply rate of resin microparticle-containing slurry: 25 mL/min
Atomizer rotation speed: 12,000 rpm
Air volume: 2 m³/min
Inlet temperature (the temperature of the inlet provided in the spray dryer and through which the resin microparticle-containing slurry is sprayed and introduced): 120° C.
Outlet temperature (the temperature of the powder outlet provided in the spray dryer and from which resin microparticle granules are discharged): 70° C.

Table 1 shows the properties of the obtained dried product of resin microparticles E6. The amount of surfactant residues in the dried product of the resin microparticles E6 was a total amount of 0.26 mass % of sodium dodecylbenzenesulfonate and 0.61 mass % of Noigen EA-167.

### Comparative Example 1

A dried product of resin microparticles R1 was obtained in the same manner as in Example 1 except that 1.8 parts by mass of the antioxidant dispersing liquid A prepared in Production Example 2 was not added. Table 1 shows the properties of the obtained dried product of resin microparticles R1.

### Comparative Example 2

A dried product of resin microparticles R2 was obtained in the same manner as in Example 6 except that the monomer components used were 35 parts by mass of butyl acrylate, 21 parts by mass of styrene and 14 parts by mass of ethylene glycol dimethacrylate, and 1.8 parts by mass of the antioxidant dispersing liquid A prepared in Production Example 2 was not added. Table 1 shows the properties of the obtained dried product of resin microparticles R2.

The silicon element content of the dried product of resin microparticles R2 was ND (less than the lower detection limit).

In addition, the amount of surfactant residues in the dried product of resin microparticles R2 was a total amount of 0.21 mass % of sodium dodecylbenzenesulfonate and 0.60 mass % of Noigen EA-167.

### Comparative Example 3

A resin microparticle-containing slurry R3 was obtained in the same manner as in Example 1 except that 1.8 parts by mass of the antioxidant dispersing liquid A prepared in Production Example 2 was not added, and 0.7 parts by mass of pentaerythritol tetrakis[3-(3′,5′-di-t-butyl-4′-hydroxyphenyl)propionate](melting point 125° C.) was added.

The obtained resin microparticle-containing slurry R3 was in an aggregated state, and it was difficult to extract resin microparticles R3. Therefore, the properties (the volume average primary particle size, the coefficient of variation of the volume average primary particle size, the silicon content, the 3% decomposition temperature in an air atmosphere, the 3% decomposition temperature in an inert gas atmosphere and the amount of surfactant residues) of the dried product of resin microparticles R3 could not be measured, and the properties were not shown in Table 1.

TABLE 1

| | Example | | | | | | Comparative Example | | |
|---|---|---|---|---|---|---|---|---|---|
| | 1 | 2 | 3 | 4 | 5 | 6 | 1 | 2 | 3 |
| Volume average | 0.38 | 0.38 | 0.38 | 0.38 | 0.38 | 0.38 | 0.38 | 0.38 | Not |
| primary particle | | | | | | | | | measurable |
| size [μm] | | | | | | | | | due to |
| Coefficient of | 14 | 14 | 14 | 14 | 14 | 14 | 14 | 14 | aggregation |
| variation of volume | | | | | | | | | |
| average primary | | | | | | | | | |
| particle size [%] | | | | | | | | | |
| Silicon element | 0.18 | 0.17 | 0.17 | 0.18 | 0.17 | 0.17 | 0.18 | ND | |
| content | | | | | | | | | |
| [mass %] | | | | | | | | | |
| 3% Decomposition | 320 | 328 | 322 | 308 | 322 | 318 | 275 | 270 | |
| temperature in air | | | | | | | | | |
| atmosphere [° C.] | | | | | | | | | |
| 3% Decomposition | 346 | 362 | 349 | 343 | 348 | 355 | 340 | 338 | |
| temperature in | | | | | | | | | |
| inert gas | | | | | | | | | |
| atmosphere [° C.] | | | | | | | | | |
| Amount of | ND | ND | ND | ND | ND | 0.87 | ND | 0.81 | |
| surfactant residues | | | | | | | | | |
| [mass %] | | | | | | | | | |

The present invention can be implemented in various other embodiments without departing from its spirit and main characteristics. Therefore, the above examples are only examples in all respects and should not be construed as limiting. The scope of the present invention is defined by the scope of claims, not the text of the specification. In addition, the scope of the present invention also includes all modifications and changes within the equivalents of the scope of claims.

1. Resin microparticles obtained by polymerizing vinyl-based monomers, the resin microparticles comprising:
an antioxidant with a melting point of 30° C. or higher and 105° C. or lower; and
a multifunctional thiol compound and/or a monofunctional thiol compound having an alkyl group having 1 to 9 carbon atoms in a molecule,
the resin microparticles having a volume average primary particle size of 0.05 m or more and 3.0 m or less, and
a coefficient of variation of the volume average primary particle size of 20% or less.

2. The resin microparticles according to claim 1,
wherein a silicon element content in the resin microparticles measured by fluorescent X-ray analysis is 0.03 mass % or more and 1 mass % or less.

3. The resin microparticles according to claim 1,
wherein a 3% decomposition temperature in an air atmosphere is 290° C. or higher, and a 3% decomposition temperature in an inert gas atmosphere is 340° C. or higher.

4. The resin microparticles according to claim 1,
wherein the vinyl-based monomers include a monofunctional (meth)acrylic acid ester-based monomer having an alkyl group having 1 to 8 carbon atoms.

5. The resin microparticles according to claim 1,
wherein the vinyl-based monomers include a monofunctional aromatic vinyl-based monomer.

6. The resin microparticles according to claim 1,
wherein the vinyl-based monomers include a multifunctional vinyl-based monomer.

7. The resin microparticles according to claim 1,
wherein the resin microparticles contain a non-crosslinkable polymer component made of a monomer component containing a (meth)acrylic acid ester-based monomer or an aromatic vinyl-based monomer.

8. The resin microparticles according to claim 1, which are used as an anti-blocking agent for a resin film.

9. The resin microparticles according to claim 8,
wherein the resin film is an optical film.

10. A method for producing resin microparticles, the method comprising a process of performing, in an aqueous medium, a heat treatment on a mixture of polymer particles obtained by polymerizing monomer components, and an antioxidant or an antioxidant dispersing liquid,
wherein the monomer components include a monofunctional (meth)acrylic-based monomer or a monofunctional aromatic vinyl-based monomer.

11. The method for producing resin microparticles according to claim 10,
wherein the temperature during the heat treatment is equal to or higher than a melting point of the antioxidant and 120° C. or lower.

12. The method for producing resin microparticles according to claim 10,
wherein the polymer particles are polymer particles obtained by seed polymerization, emulsion polymerization or soap-free polymerization.

13. The method for producing resin microparticles according to claim 10,
wherein the polymer particles are polymer particles polymerized in the absence of a water-soluble polymer.

14. The method for producing resin microparticles according to claim 10, further comprising a process of granulating and drying the resin microparticles.

15. The method for producing resin microparticles according to claim 10, further comprising a process of dry-classifying and/or wet-classifying the resin microparticles.
